(19) United States
(12) Patent Application Publication
(10) Pub. No.: US 2010/0106533 A1
(43) Pub. Date: Apr. 29, 2010

(54) Methods and Systems for Risk Management

(76) Inventor: Armando Alvarez, New York, NY (US)

Correspondence Address: BOND, SCHOENECK & KING, PLLC, ONE LINCOLN CENTER, SYRACUSE, NY, 13202-1355, US

(21) Appl. No.: 12/519,492

(22) PCT Filed: Dec. 17, 2007
(86) PCT No.: PCT/US07/87800

§ 371 Date: Dec. 7, 2009

Related U.S. Application Data
(60) Provisional application No. 60/875,163, filed on Dec. 16, 2006.

(51) Int. Cl. G06Q 40/00; G06Q 10/00

(52) U.S. Cl. 705/4; 705/301; 705/9

(57) ABSTRACT

Methods and systems for managing risk are described in which information related to one or more aspects of risk are received from a plurality of users, which is stored in a database system. Various insurance business process applications corresponding to the one or more aspects of risk can Abe run to process the information, and graphical interfaces for providing risk management information to the users can be populated, and various tasks or reminders based on the processed information generated for user review.

### RELATED APPLICATION

The present application claims benefit of and priority to: (i) PCT patent application PCT/US2007/087800 filed 17 Dec. 2007; and (ii) provisional application Ser. No. 60/875,163, filed Dec. 16, 2006

### BACKGROUND OF THE INVENTION

1. Field of the Invention

The present invention is directed to methods and systems for performing risk management business processes and functions including, without limitation, risk identification and risk assessment in the area of operational and hazard risk.

2. Description of the Related Art

Risk management is a discipline that is practiced in one form or another by most organizations. It is becoming increasingly important as risks and hazards are growing more complex and difficult to identify in the inter-linked global economy. A risk manager, by definition, is a knowledge worker that helps an organization identify, minimize and mitigate risks to the organization. Where there is no formal risk manager the function is usually shared by other officers of the organization (e.g., Treasurers, Legal Counsel, etc.). The duties of a risk manager can be summarized into five general categories: Collect information (risk related); Assess information (e.g., risks); Provide opinions (e.g., review contracts, set standards); Collaborate regarding risk-related subject matter; and Manage vendors (e.g., purchase insurance, secure engineering services, etc.). In short, the role of the risk manager is becoming increasingly important and the need for productivity tools is correspondingly becoming more pronounced.

A survey of the current productivity tools available to a risk manager reveal that the tools can be too manual-intensive, limited in terms of collaboration, data-centric (e.g., claims), and not adaptive. These conditions can limit the productivity and business intelligence benefits to the risk manager and the organization, and can potentially add more risk to an organization due to: Limited view of risk across the organization; Poor or slow risk assessments; and Underperforming resources (colleagues and vendors).

There has not been any suitable attempt at developing an acceptable unifying operating platform that suitably automates the various business processes in support of the risk management objectives of an organization. Thus, the related art lacks effective methods and systems for bringing together typically disparate risk factors and providing a platform for the management of all such risk factors in an integrated fashion.

### BRIEF SUMMARY OF THE INVENTION

At least some embodiments of the present invention combine processes and functions that can be used to implement and manage an integrated risk management operating systems. The platforms and applications of at least some embodiments of the present invention are generally rules-based web services designed from the ground up to provide customers with flexibility to configure their solutions as necessary to meet the unique needs of their organizational structure and business. The platform can be designed to digitize in a customized configuration, all aspects of a business process including, for example: Participant roles and profiles; Authentication and authorization access; Data definitions; User interfaces; Approval workflows; Monitoring and alert conditions; and Reporting.

For example, an embodiment of the invention may include a platform preferably comprising three programming layers: a process server, a risk module, and one or more insurance business process applications (see FIG. 1). In this example, the process server is an infrastructure layer that consists of a collection of internal services, frameworks, and application building blocks that are used extensively by upper layers. The platform preferably supports any number of concurrent business applications, although customers may have the option to buy only a subset. In addition, the platform is preferably designed and configured to be expandable such that, as new applications are developed in the future, they can be easily added to an existing customer instance.

In some embodiments of the present invention, the risk module may be an on-demand risk management portal that serves as the foundation for all insurance business process applications and provides out-of-the box features for managing insurance policies, sharing documents, educating the workforce, and managing projects. Insurance business process applications are generally solutions that address a specific risk management process such as certificate tracking or exposure data collection.

### BRIEF DESCRIPTION OF THE DRAWINGS

In the drawing figures, which are not to scale, and which are merely illustrative, and wherein like reference numerals depict like elements throughout the several views:

FIG. 1 is an overview of a system architecture in accordance with a preferred embodiment of the present invention;

FIGS. 2-24 depict examples of various graphical user interfaces for displaying and receiving information in accordance with preferred embodiments of the present invention;

FIG. 25 is a schematic view of a contract workflow according to an embodiment of the present invention; and

FIGS. 26-32 depict examples of various graphical user interfaces for displaying and receiving information in accordance with preferred embodiments of the present invention.

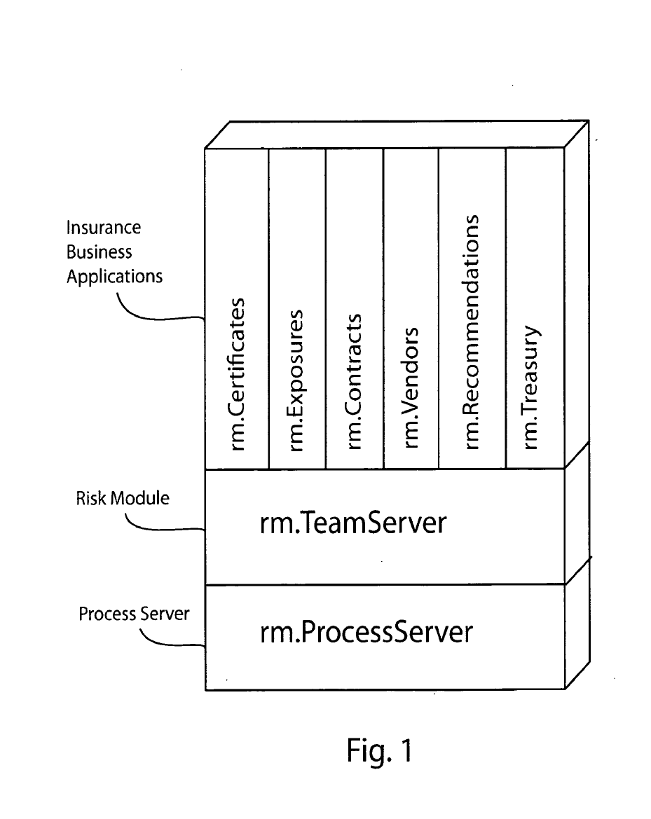

### DETAILED DESCRIPTION OF PREFERRED EMBODIMENT(S)

A platform in connection with preferred embodiments of the invention can include a process server. The process server is an infrastructure layer including several internal services and application building blocks that include, but are not limited to: security services framework, workflow and business rules, extensible data model and flexible forms, flexible risk metrics, and flexible reporting. The security services framework handles access control to the system by providing functions for creating and managing user accounts, performing user authentication and determining which resources and functions the user is authorized to access.

It should be noted that although the embodiments described herein include separate servers and databases for performing the various functions of the risk management platform, other embodiments could be implemented by storing the software or programming that operates the described functions on a single server or any combination of multiple servers as a matter of design choice. Although not depicted in the Figures, the server systems generally include such art recognized components as are ordinarily found in server systems, including but not limited to processors, RAM, ROM, clocks, hardware drivers, associated storage, and the like. One skilled in the art will recognize, however, that because multiple users may be accessing such servers at any given time it is preferable to utilize multiple servers and databases. Multiple servers may be used separately or in tandem to support the systems traffic and processing. For example, a round-robin configuration utilizing multiple server systems may be used as the in some preferred embodiments of the present.

Moreover, as will become evident from the following description and associated FIGS., users are in communication with the risk management platform via global communication networks, such as for example, the Internet, cellular, satellite or other wireless communication network. One skilled in the art will also recognize that network may also include a non-wireless component, such as, for example, the Public Switched Telephone Network (PSTN), cable or fiber optic networks. It will also become apparent, that the various system components of the risk management platform are communicatively coupled to one another via a communication network such as local or wide area network (LAN or WAN).

End user computers may be any type of personal or network computer such as an IBM-compatible computer running an Intel chipset and having an operating system, such as Microsoft Windows Vista, NT, 2000, XP, and the like, and, preferably, running a browser program such as Microsoft Internet Explorer or Netscape Navigator. It is also within the scope of the present invention that end user computers may be handheld or table computing devices, such as a personal digital assistant (PDA), pocket PC, and tablet PC, or the like. The end user computers also preferably have access to a communications network via a modem or broadband connection to permit data communication between the end user computers and the risk management platform.

Various input and output devices are also preferably provided with the end user computers including, by way of non-limiting example, a display (e.g., cathode ray tube (CRT), liquid crystal display (LCD), etc.), and an input device (e.g., a keyboard, mouse, touch pad, or light pen). The end user computers would also preferably include a storage device such as, for example, a magnetic disk drive and magnetic disk, a CD-ROM drive and CD-ROM, DVD, or other equivalent device. The specific hardware combination and configuration is not crucial to the instant invention, and may vary as a matter of design choice within the functional parameters disclosed herein.

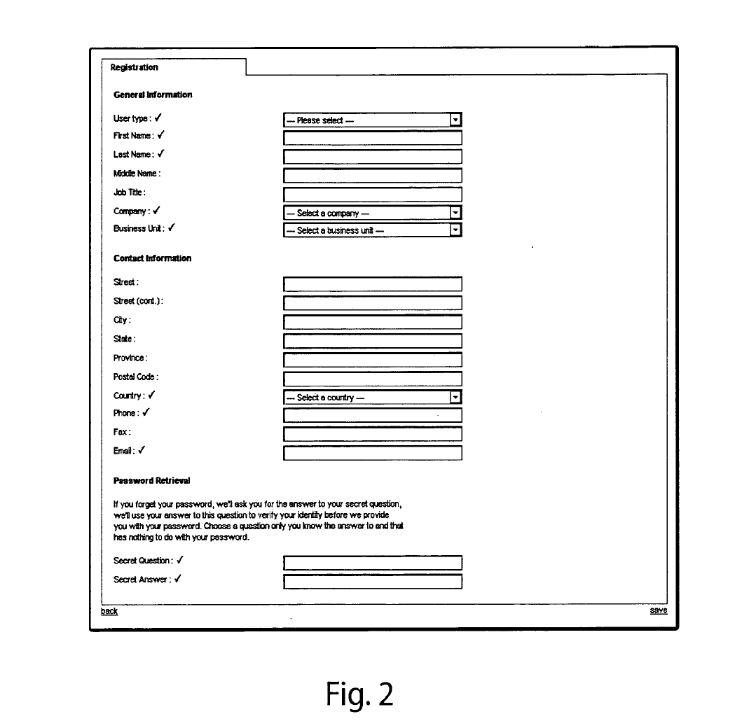

In operation, there are preferably several ways to create new user accounts. System administrators can create individual user accounts at any point on an ad hoc basis. In addition, a self-registration feature may be provided to permit potential users to apply for an account using an interface such as is shown in FIG. 2. Account requests preferably can be automatically approved, denied, or alternatively sent for approval. The platform is preferably configured such that the rules that govern these decisions may be customized by system administrators. A highly secure, password-based authentication scheme is preferably used by default, but other authentication schemes such as single sign-on may also be supported. Various strong password policies can be configured to meet the client's corporate security standards. Some of these options include limits on maximum and/or minimum password age, limits on maximum or minimum password length, password hashing, and prohibitions against the emailing of passwords.

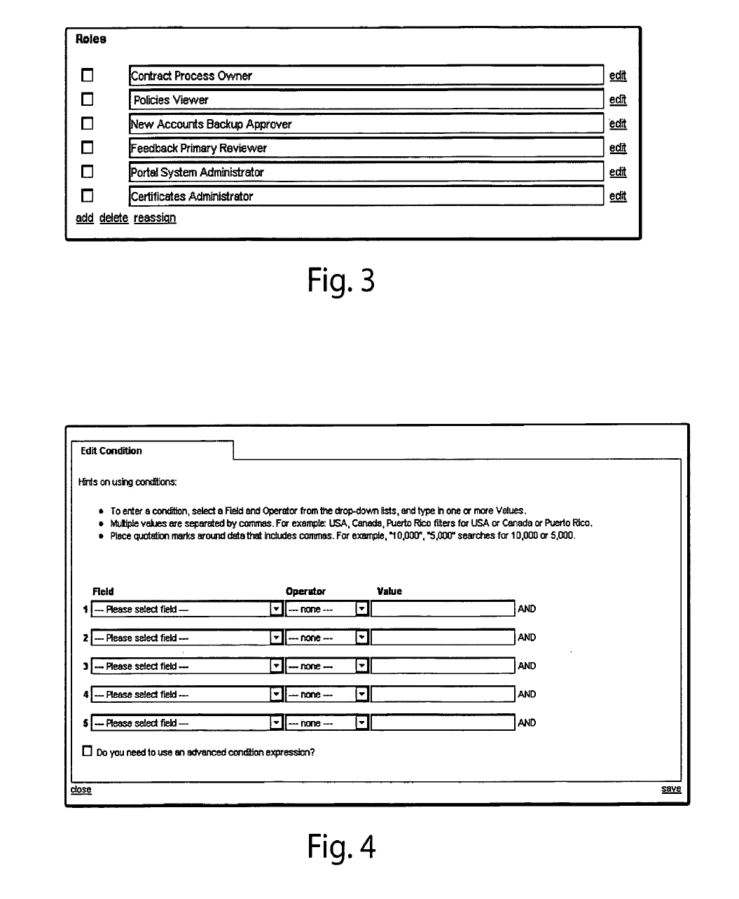

Access to resources and business functions within the system are managed by using roles that map to specific job functions within an organization. Each role is given one or more permissions that enable users assigned to the role to perform actions in accordance with any relevant business rules. Individual user accounts and groups can be assigned several different roles as required using an interface such as is shown in FIG. 3.

The platform can also be configured to fully accommodate differences in processes adopted by customers. For example, one customer may require a contract to be reviewed by a service provider; a second customer may require that the contract be reviewed by two service providers in sequence; and a third may require two service providers to review the contract, but allow them to work in parallel.

Workflows also help manage business processes (e.g., certificate approval, contract review) efficiently by enforcing standards, minimizing overhead, eliminating delays, and improving accountability and cycle times. The workflow framework of the platform provides the infrastructure for defining and maintaining flexible and highly configurable workflows. Workflows are preferably configured online using a point-and-click interface without the need for coding or complicated, expensive tools. In particular, the workflow framework is used to define application events that trigger workflow transitions, such as submitting a contract for review. The workflow framework may also be used to define actions such as assigning tasks, sending emails, escalations and reminders.

Due to the flexibility of the architecture, workflow definitions and associated rules, events, actions, escalations, reminders, task and email templates can be more efficiently modified to keep pace with changing processes and evolving business needs.

Customer-specific workflow rules can also be efficiently created and maintained using a point-and-click interface as shown in FIG. 4. Rules follow an event-action paradigm whereby a rule can be triggered based on any business event and conditionally cause several actions to take place such as dynamically assigning a task to a user based on her role, sending an email, and/or other custom actions.

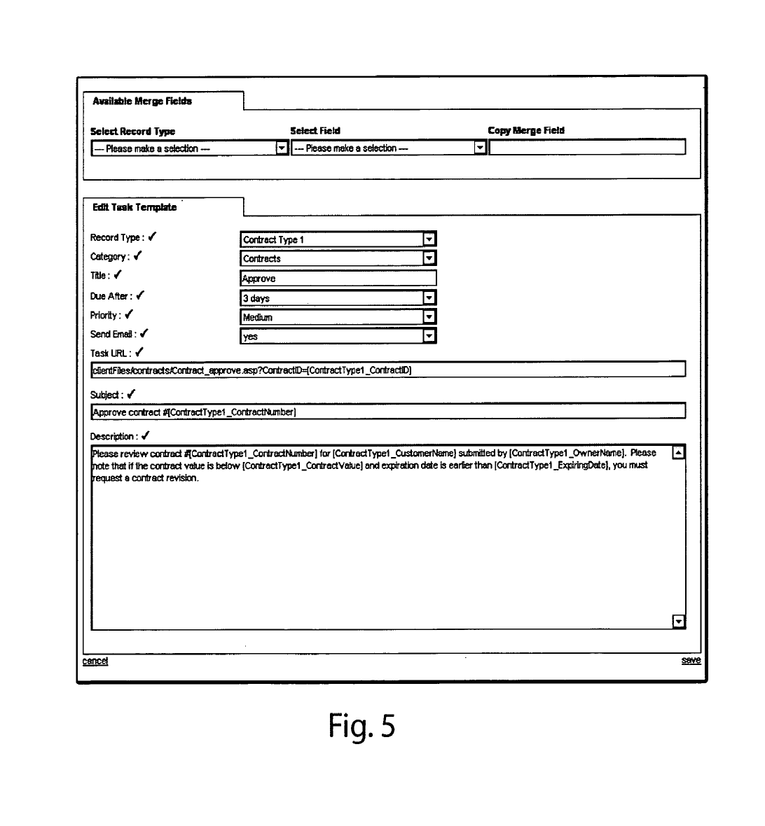

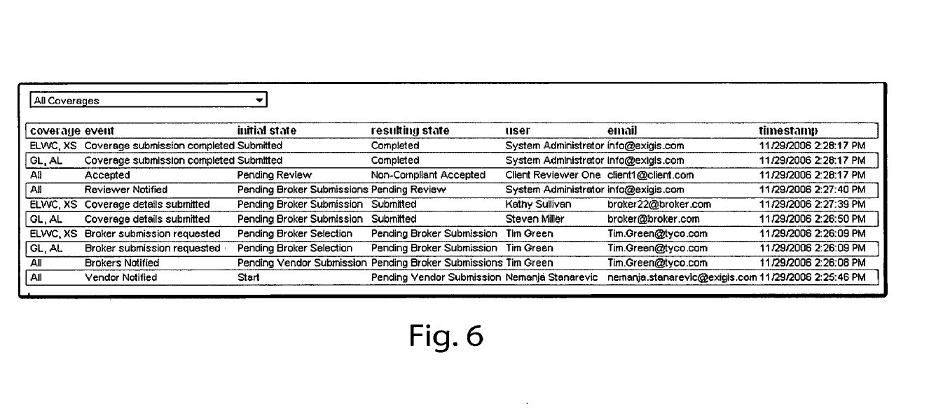

Task and email templates can also be pre-defined and updated using a point-and-click interface as shown in FIG. 5. Templates can be populated with standard data such as subject, priority, status, as well as placeholders that are dynamically replaced with record-specific information. Email language and instructions can be quickly customized and updated to meet customer requirements and feedback. As shown in FIG. 6, audit trail functions may be integrated within the workflow engine to capture a detailed event history of all workflow transitions.

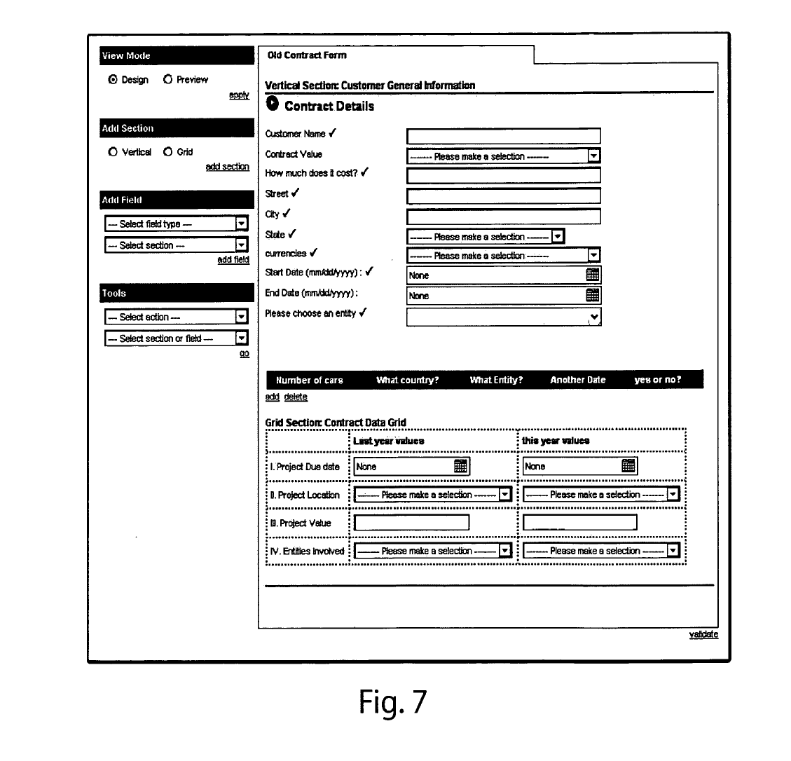

The platform's applications include a standard database setup, with default tables, fields, and relationships, but most organizations will have their own unique needs that cannot be addressed with a rigid, inextensible data model. Data model customizations are performed online using a very simple point-and-click approach for manipulating fields. Complex forms may be put together quickly by non-programmers and future changes are made with the same ease. Using an interface, such as shown in FIG. 7, customers can have their solutions configured with additional fields and form layouts based on internal or industry best practices. As a result, the platform can be designed and configured to meet the direct business needs of the particular customer, rather than being designed and configured for another company or according to a pre-defined model.

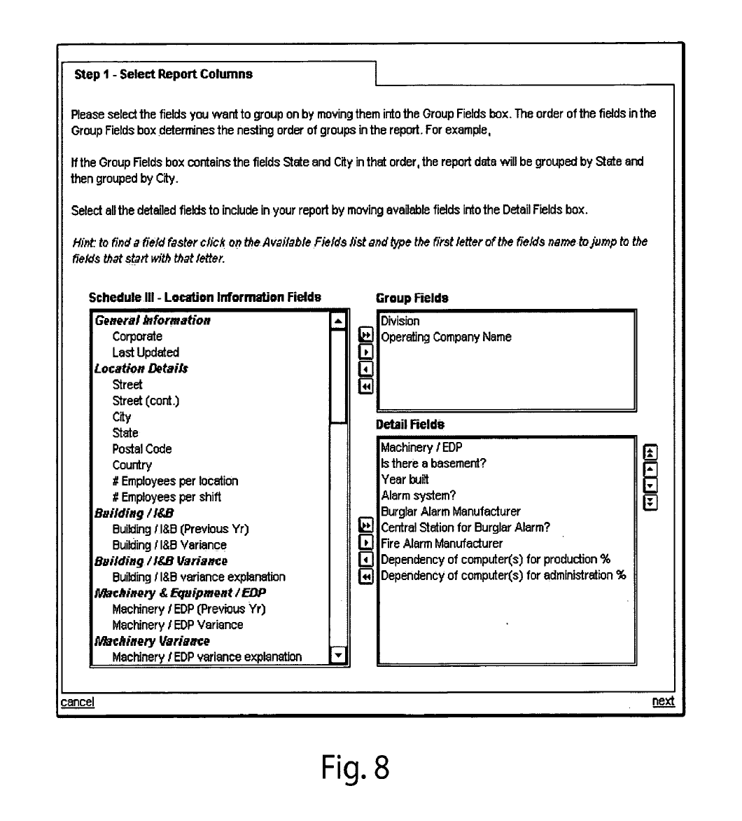

Reporting tools enable customers to access application, workflow, or any other kind of data stored in the system in a simple, consistent and powerful manner. Standard reports can be a good starting point by providing immediate insight into typical business scenarios based on standard application fields. In addition, using the interface shown in FIG. 8, end users can create ad hoc reports using a simple step-by-step wizard that provides options to specify report columns, filters, grouping, sorting, formatting, and mathematical formulas to aggregate and perform calculations on raw data.

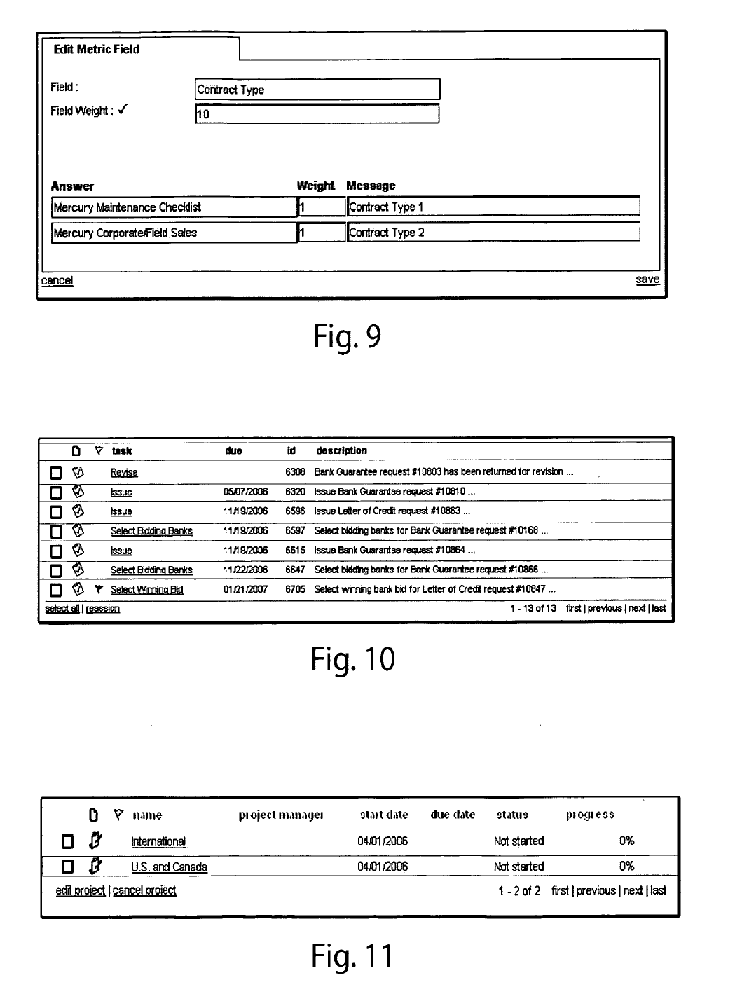

The platform's applications and workflows generate a large number of records with many data points. Risk indexing technology makes it possible to define arbitrarily complex risk scores and other performance indicators for different records types which are then evaluated on an individual record basis. Similarly to flexible reports, risk scores can be defined, updated and managed in an ad hoc fashion (e.g., FIG. 9) to be aligned with the customer's internal standards, goals and initiatives.

The workflow framework can be used to capture and streamline complex processes with large numbers of participants and intricate interactions. Workflows are preferably designed to emphasize order and enforce standards, and so by their nature workflows tend to be rigid and very structured. In many cases it is important to allow process participants to collaborate more freely in an ad hoc fashion outside the constraints of pre-defined workflows. To address this need, process server provides ad hoc collaboration tools such as ad hoc tasks, emails, reminders, and diary functionality. All these functional pieces are bundled in the collaboration bar which can be attached to any record of any application, thus allowing participants of any process to collaborate more effectively.

The risk module is preferably an on-demand risk management portal that serves as the foundation for all insurance business process applications. It provides out-of-the box features for managing insurance policies, sharing documents, educating the workforce, and managing projects. Some preferred, specific components and functionality of the risk module will now be described.

A. Inbox

Inbox is a repository for all tasks that have been assigned to a user, as shown in FIG. 10. Common tasks include: approving certificate requests, reviewing feedback, approving new portal accounts, and answering a question. Tasks can be assigned automatically from workflows or in an ad hoc fashion from other portal users.

B. Projects

The Projects application allows users to keep an interactive project based to-do list. Projects are created, and within these projects, tasks (or to-do items) are added. Tasks may be assigned to an individual or groups of individuals (groups or teams). The project manager should be able to view the progress that has been made on a task or project, as shown in FIG. 11. The application also supports ad hoc tasks which are added to the task list, and are not linked to a project.

C. Documents

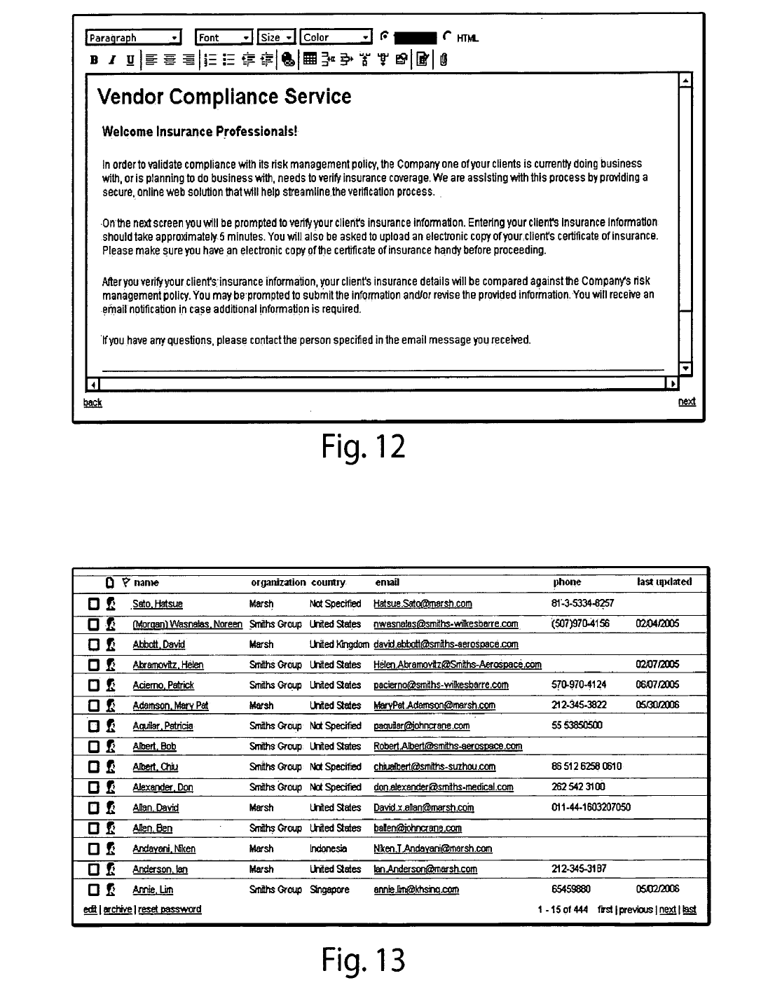

The Documents application can serve as the content management system for the risk module. It allows a user to add content by either creating documents via an online WYSIWYG HTML editor (e.g., FIG. 12) or by uploading file(s) from a local computer. Furthermore, the HTML editor supports copying and pasting text from an existing document. The application preferably has a content versioning system and a configurable publishing workflow. Content can be rated through feedback to ensure that it is relevant and current. Company risk policies and procedures, and any other relevant material can be published for public view.

D. Contacts

The Contacts application can allow portal administrators to add, edit, archive and track information about portal users, as shown in FIG. 13. Additional useful functions may include exporting the contacts listing to an Excel spreadsheet and resetting passwords.

E. Policies

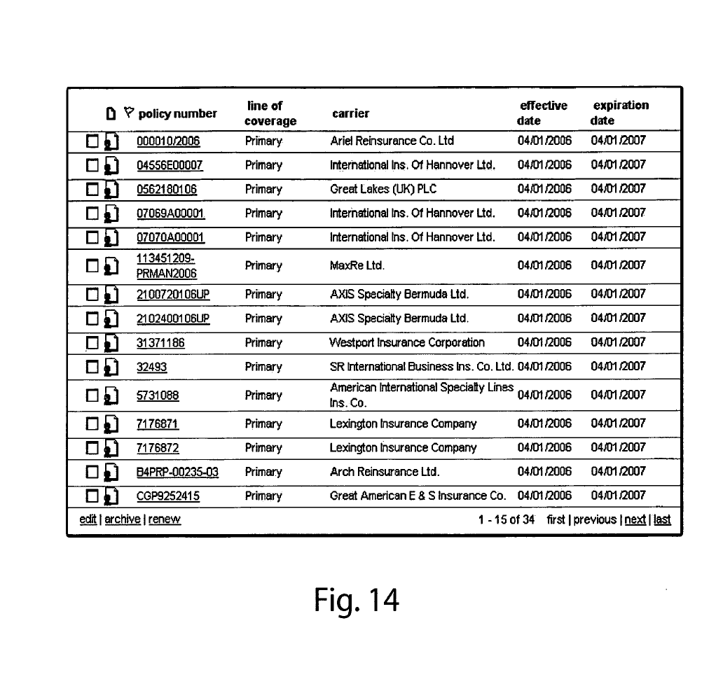

The Policies application can be used to add, track, edit, and archive insurance policies, as shown in FIG. 14. Additionally, information about insurance carriers, brokers, and insurance programs can be captured using this application. The application can preferably be customized with any number of additional fields and/or workflows to meet the needs of the customer. Certificates application makes use of Policies to store and retrieve policies and related information that appears on certificates of insurance.

F. Reports

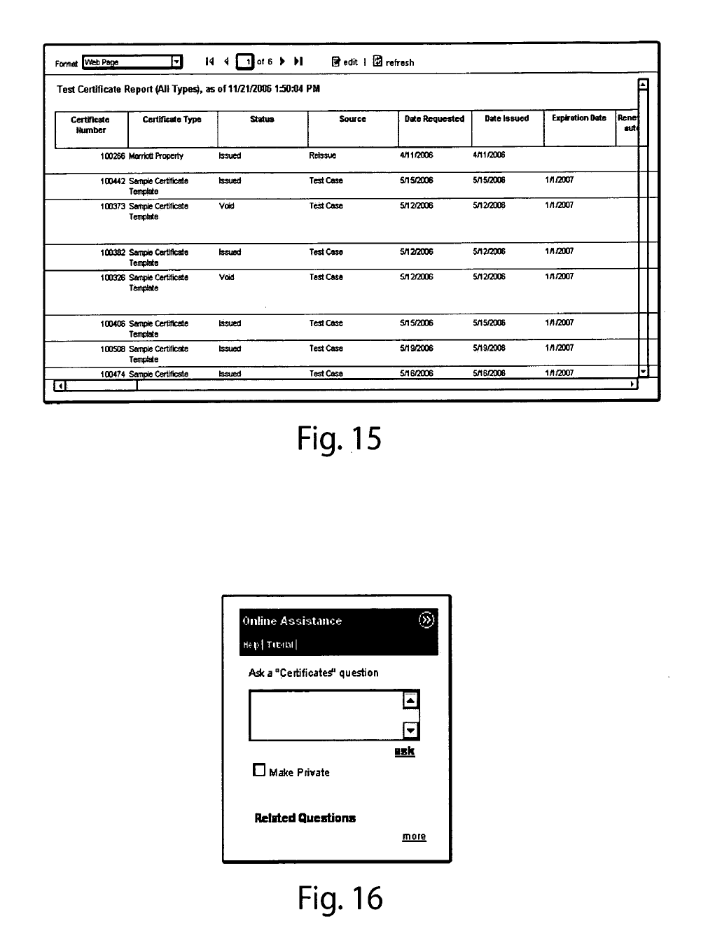

The Reports application can be the front-end to the standard and ad hoc reporting capabilities of the core platform, as shown in FIG. 15. In addition, it preferably supports the ability to restrict access to reports based on portal roles and permissions. It preferably gives the author of a report the ability to lock reports and disallow other users from making changes.

G. Online Assistance

Online Assistance can include a set of tools to facilitate and enhance user experience and collaboration. In this preferred embodiment, users can utilize online assistance tools to: (i) ask questions, such as through the interface shown in FIG. 16, to knowledge experts; (ii) view tutorials; and (iii) view help files related to the specific application on which they are working. The content for online assistance can be managed using Documents and so it can be easily modified to align with customer's terminology, special needs and feedback.

Insurance business process applications are solutions that address a specific risk management process such as certificate tracking or exposure data collection. Customers can decide to buy any number of business applications and they can add more at any point in time. In addition, as new applications are developed and become available in the future, they can be easily added to an existing customer instance.

The certificates module can be a request fulfillment application that allows users to request various types of certificates of insurance and receive them online. Standard certificates that comprise most of the volume have default limits and pre-determined language and are issued instantaneously. Non-standard certificates are intended to accommodate wider needs, and typically require approval. Offline certificates are not issued online and could require interaction with back office systems.

The configuration and setup of the certificates module is preferably handled via an online administration user interface and does not require any programming. Business analysts and implementation engineers are able to configure certificate layouts, language, request forms, and approval rules to the particular needs of the customer.

Certificate layouts are preferably configured as PDF files that include the layout and formatting specification of certificates of insurance. The certificates module supports most standard industry layouts, such as ACORD, as well as custom layouts specific to a customer's requirements.

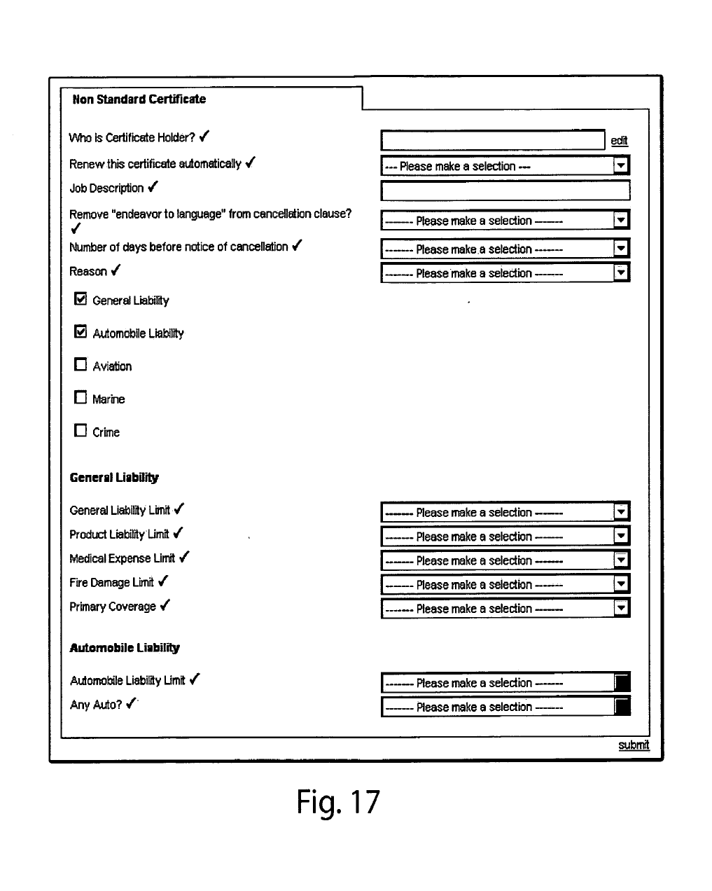

Each installation of the certificates module preferably contains one or more certificate templates or types, for example there could be a liability and a property template. Templates determine the certificate request form that is displayed to the certificate requestor. All certificate request forms, as shown in FIG. 17, can have a few standard fields such as certificate holder and named insured, but since most request forms vary largely from one customer to another, they are typically extended with custom fields.

Certificate approval and escalation rules are preferably template-specific. That is, a separate set of approval rules can be configured for each template. Approval rules can consist of conditional logic statements that reference the fields of an extended certificate record. Rules can be efficiently configured to support both serial and parallel approval workflows. The application can provide three approval roles: primary, backup, and overseer. Escalation rules can be efficiently configured to specify timeframes when approval tasks are escalated from one role/level to another. Ad hoc reassignment of approval tasks is also preferably supported.

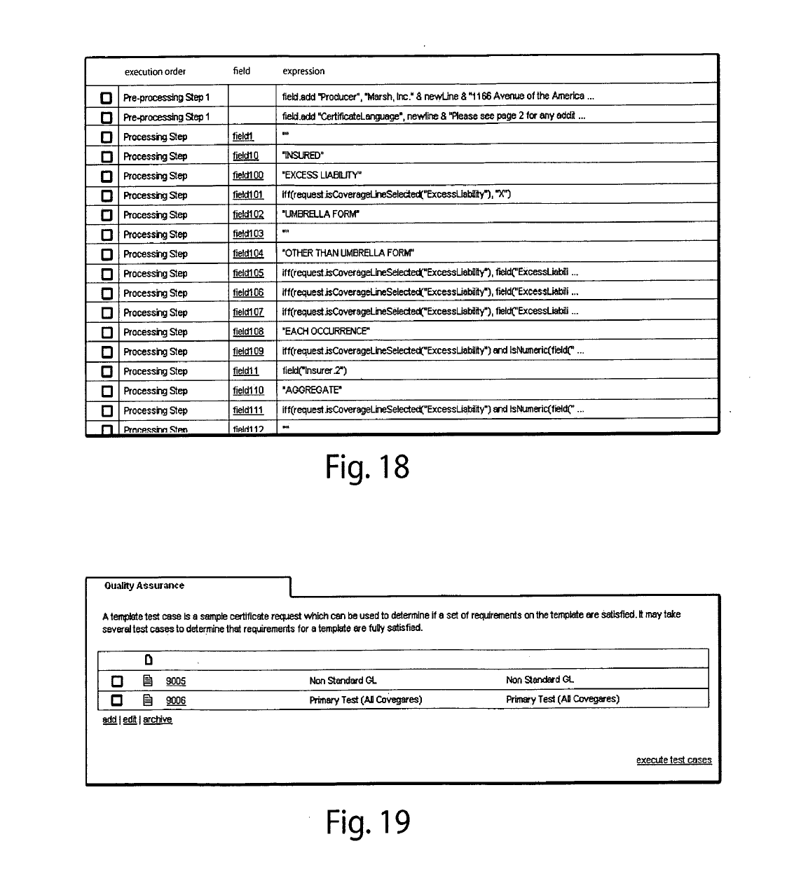

Certificate issuing rules, as shown in FIG. 18, preferably provide the link between a certificate request record and policy repository on one hand and the actual certificate document on the other. Each area of the layout file can be mapped to an issuing rule that fills out the certificate document with details coming from both certificate request records and policy information. The application is preferably pre-configured with issuing rules for standard layouts and further customizations are simple to perform.

Customers often require layout or template changes that affect the final output of a certificate document. The certificates module can be configured with a set of test cases, as shown in FIG. 19, for each template that can be sent for review and approval to a designated customer contact.

When insurance policies that are evidenced on certificates of insurance renew, each requestor receives an email with instruction on downloading the renewed certificates directly from the website. Requestors can also opt to send renewed certificates directly to the certificate holder contact.

The exposures module is typically configured as a web-based application that streamlines the exposure data collection process. Exposure data collection projects are typically conducted a few months before an insurance policy renewal date. During this time, company risk management departments can collect financial and insurance data from many people and different sources, the exposures module takes a process-centric (rather than a data-centric) approach to data collection by streamlining task assignment and delegation, highlighting progress and enforcing deadlines.

The configuration and setup of the exposures module is preferably handled via an online administration user interface and does not require any programming. Business analysts and implementation engineers are therefore able to configure business hierarchies, language, data collection schedules, and review rules to the particular needs of the customer.

The exposures module can be configured to use any business and/or reporting hierarchy in the customer's organization. The hierarchy can contain a configurable number of levels where each level is named differently, for example there could be three levels: corporate, operating company and location.

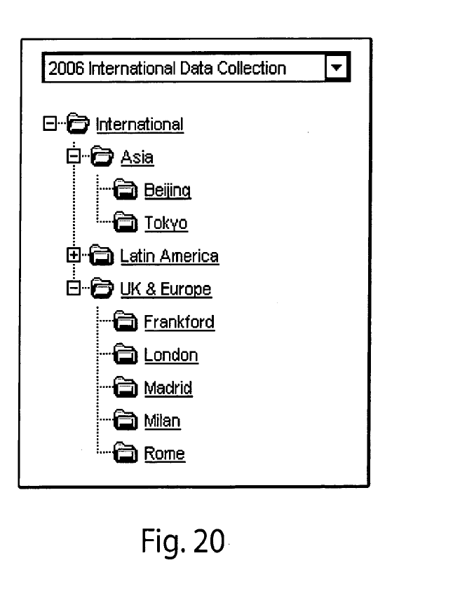

Additionally, the exposures module preferably supports multiple distinct reporting hierarchies, as shown in FIG. 20, which are very common in big international organizations with large insurance programs handled by different brokers. This feature allows several data collection projects to go on concurrently without affecting each other.

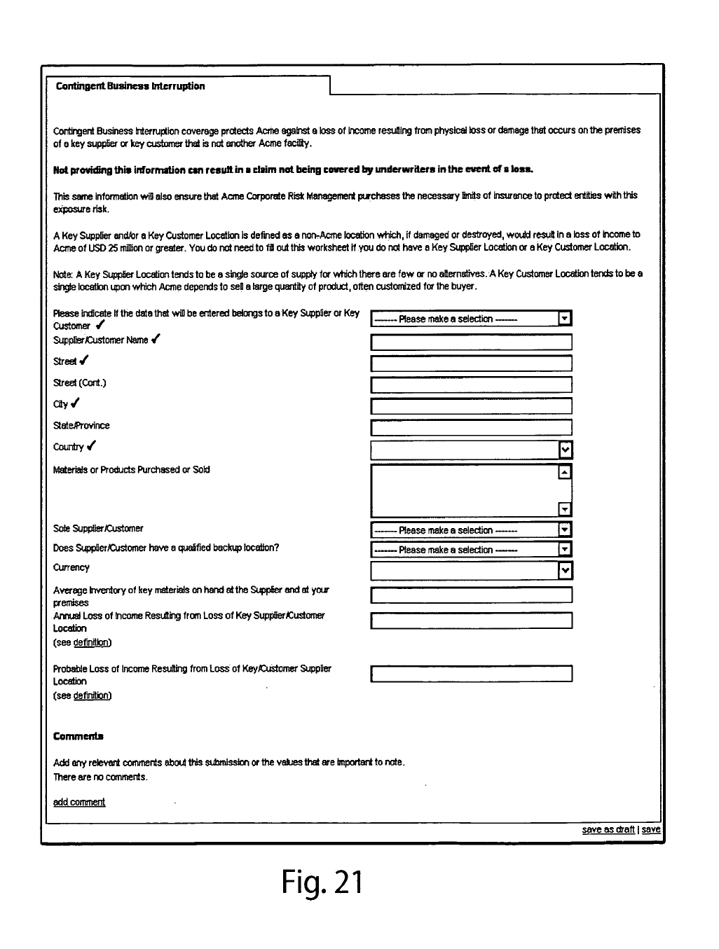

Each instantiation of the exposures module preferably contains several data collection schedules or exposure types, for example there could be a business interruption schedule and a property schedule. An example is shown in FIG. 21. Schedules determine the forms that are displayed and must be filled out by data collectors. All schedules have standard fields that tie them to the business hierarchy and are heavily extended with custom fields.

Delegation and reassignment features speed the process of identifying the right data providers who are changing year-to-year due to turnover or internal moves. These features are particularly important when the exact set of data collectors is not known at the beginning of the data collection project. When delegation and reassign operations are performed, the system preferably automatically sends emails with instructions to the new data collectors that are involved.

Process owners may also be enabled to lock and unlock schedules so that no changes are made by the field while they review the data. Locking can occur at any point in the data collection process and at any level of granularity including a specific node in the hierarchy.

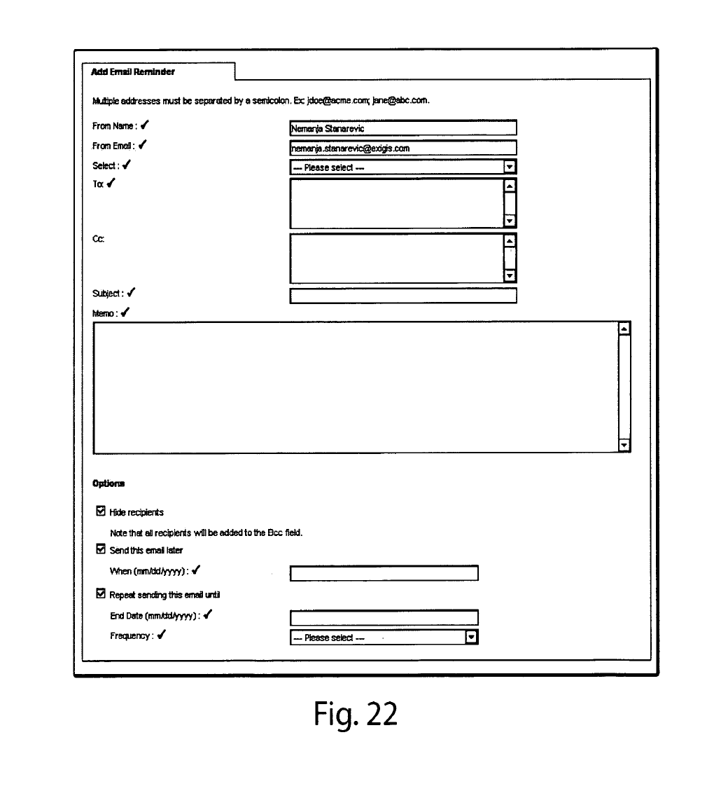

Process owners can also preferably send ad hoc email reminders (e.g., FIG. 22) to a specific set of data collectors such as those who have completed their tasks, those who have not completed their tasks, those who have never logged in, or specifically hand-picked individuals. Besides the email subject and memo, process owners can choose to send the emails at a later date and at a pre-defined frequency. Furthermore, different emails can be sent to data collectors that belong to different nodes in the reporting hierarchy.

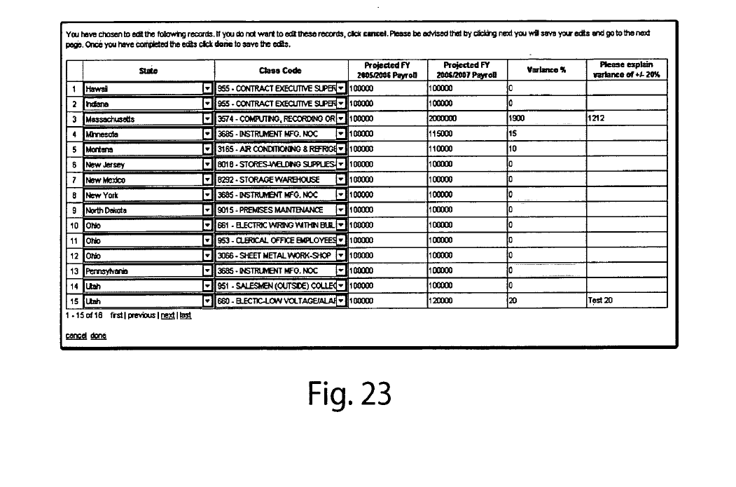

The bulk editor, as shown in FIG. 23, is used to edit more than one record at a time using an Excel-like, grid-based interface. Data collectors can use this feature to bulk edit list schedules such as automobile and/or payroll. List schedules are used when more than one record must be reported for a specific node in the hierarchy, such as all the automobiles in a location, or all employee payroll records for a business unit. Furthermore, process owners can use the bulk editor to massage data from different nodes on the hierarchy at the end of the data collection project.

The contracts module is a web application that streamlines and optimizes the contract review process. Field producers and staff submit contract requirements on electronic forms configured to accommodate the insurance requirements and business needs of the customer's organization, the contracts module then screens the electronic submissions for compliance with organizational standards and metrics. Contracts that comply with the company's risk management policy are automatically approved, whereas others are routed for appropriate level review. The contracts module automates workflow and expedites review cycle time while increasing accountability and enhancing control over the entire process.

The configuration and setup of the contracts module is preferably handled via an online administration user interface and does not require any programming. Business analysts and implementation engineers are able to configure contract metrics, language, forms, and review/approval workflows to the particular needs of the customer.

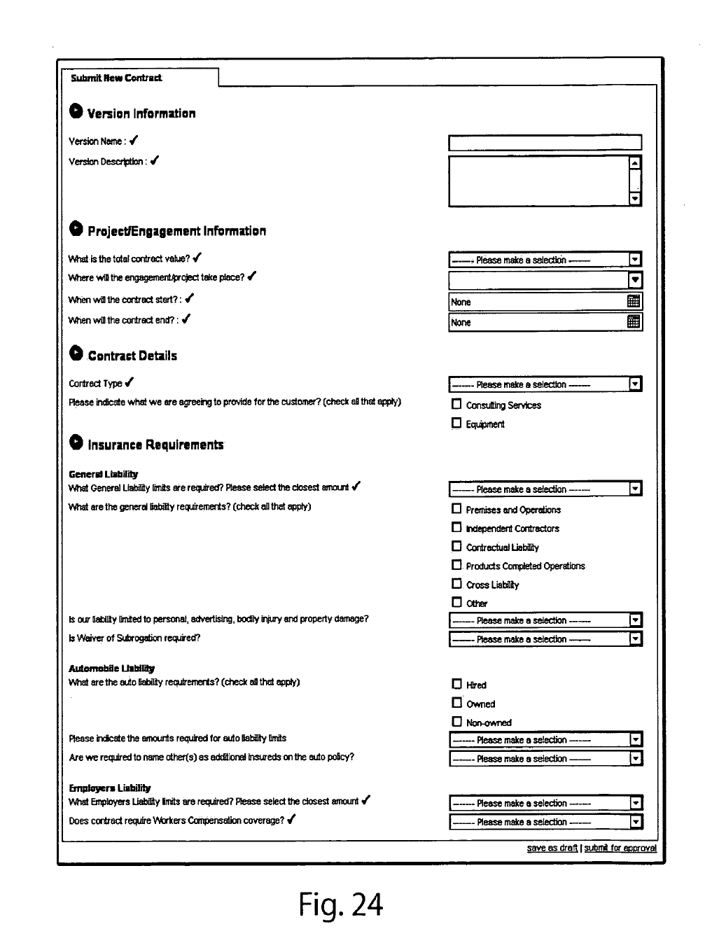

Each instantiation of the contracts module typically comprises one or more contract types, which determines the forms that are displayed and need to be filled out by end users. All contract submission forms have a few standard fields regardless of type and are further extended with custom fields to meet the exact needs of the customer, as shown in FIG. 24.

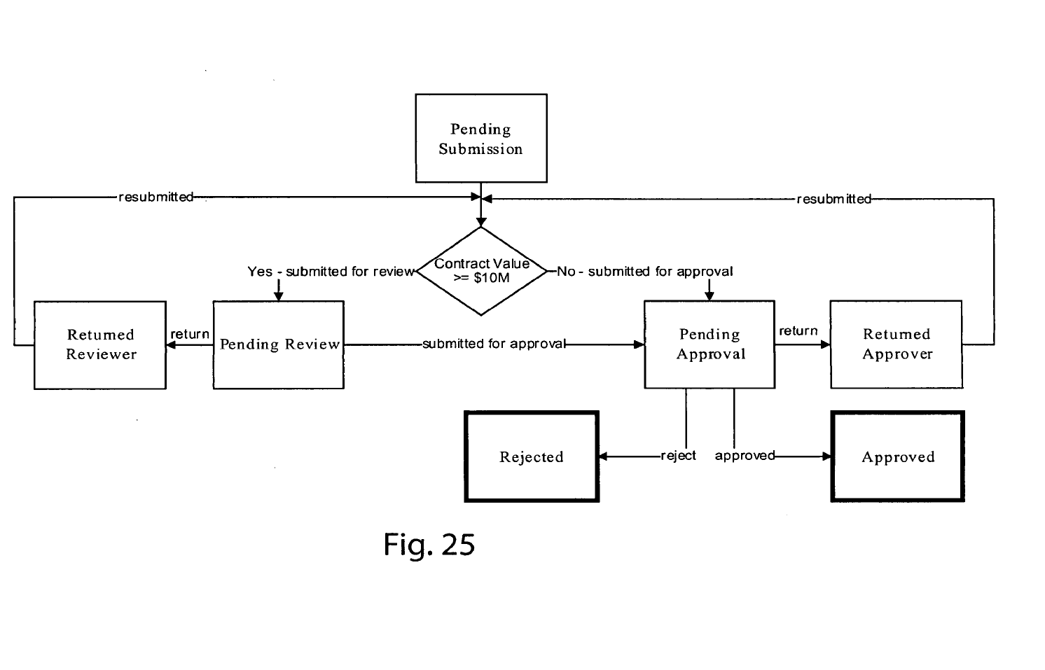

Contract review rules are typically type-specific, that is, a separate set of rules can be configured for each contract type. Review rules consist of conditional logic statements that reference the fields of an extended contract record. Rules can be configured to support both serial and parallel approval workflows with several approval levels and queues. Furthermore, escalation rules can be configured to specify timeframes when tasks are escalated from one role/level to another. Ad hoc reassignment of tasks may also supported. An example of a contract workflow is shown in the flow chart of FIG. 25.

Each contract type preferably can be configured with a pre-defined set of metrics that aim to measure the inherent risk of the contract. The actual risk score is calculated on an individual record basis and can be visualized on the contract form and/or optionally may affect the nature of the review process. For example, if the risk score is below a certain pre-defined level, the contract might not require review, as opposed to a high risk score which might require sign-off from senior management. Risk scores can be defined, updated and managed in an ad hoc fashion to be aligned with the customer's internal standards, goals and initiatives.

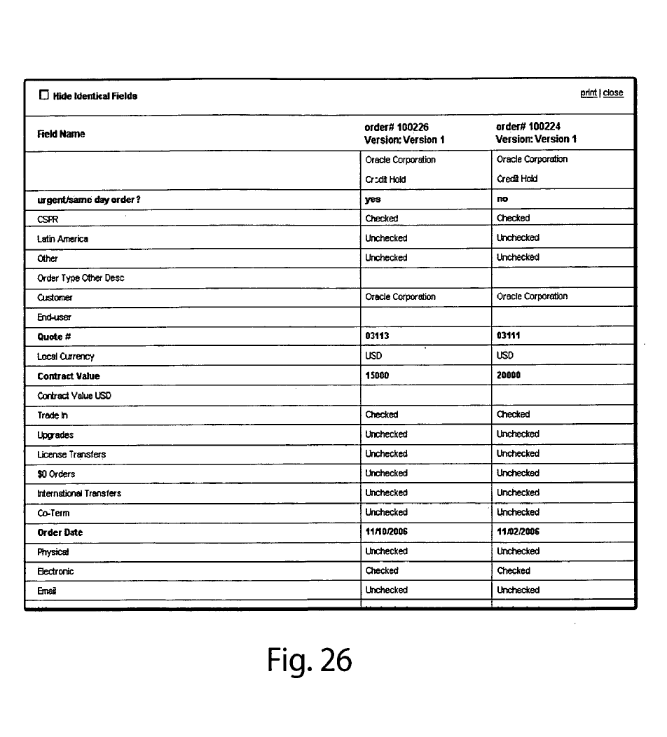

The “diff” feature can enable users to compare the metadata of two contracts or two versions of the same contract side-by-side at a field level. The user interface (e.g., FIG. 26) can make it easy to spot differences by highlighting fields with different values and giving the user the option to hide identical fields.

The vendors module can be a web application that automates and streamlines vendor insurance compliance and the tracking of incoming certificates. In this innovative approach, a Vendor's insurance provider (broker, agent, or carrier) verifies the coverage and terms that are in place for the vendor. These professionals typically have a fiduciary responsibility to assure the information is accurate. In addition they can be asked to provide an electronic copy of a Certificate of Insurance evidencing coverage. The vendors module can also preferably compare vendor insurance information against client insurance requirements and providing instant feedback. The system can also provides email notification to all relevant parties, alerts, escalation routing, archiving, pre-configured and ad hoc reports and a complete audit trail. The vendors module preferably transfers the burden of validating insurance compliance away from the system user to the Vendor seeking to do business with the system user. The vendors module aims to automate and reduce Risk Management activities around vendor compliance, improve compliance validation cycle times, eliminate errors, add rigor, control and accountability to vendor relations.

The configuration and setup of the vendors module is preferably handled via an online administration user interface and does not require any programming. Business analysts and implementation engineers are will preferably be able to configure compliance rules, language, forms, and review/approval workflows to the particular needs of the customer.

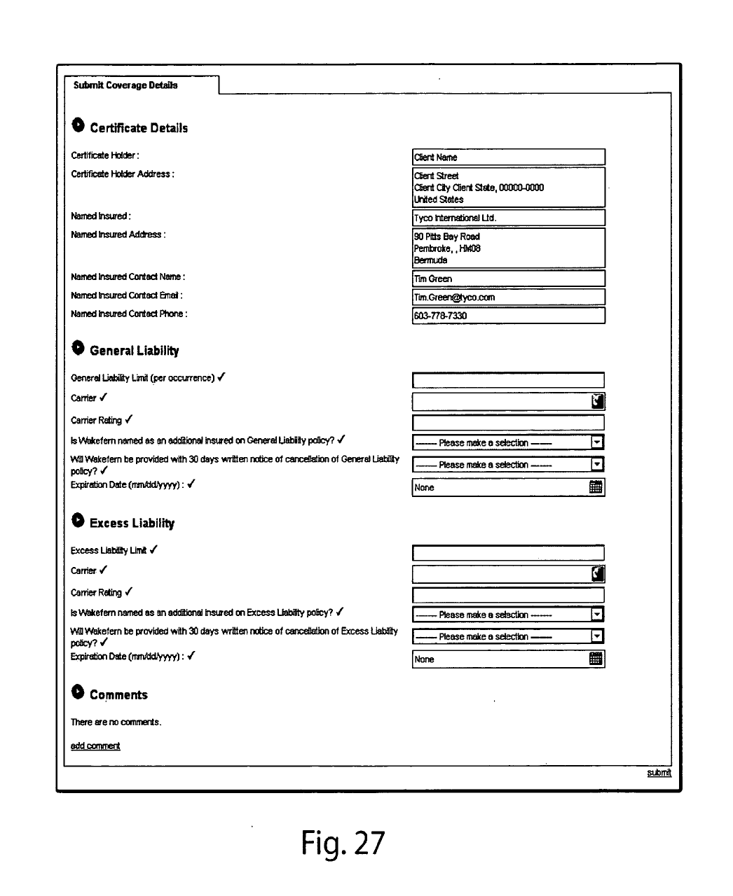

Each instantiation of the vendors module typically comprises one or more vendor types, which determines the compliance rules and forms that are displayed and need to be filled out by different types of vendors. As shown in FIG. 27, submission forms typically have a few standard fields regardless of vendor type and are further extended with custom fields to meet the insurance compliance requirements of the customer.

The insurance coverage submission workflow preferably comprises several highly configurable steps. The process typically starts when the client notifies the vendor, who then enters the contact information of her insurance providers. At this point no further action is required by the vendor unless the coverage details are not compliant. The insurance providers are notified to enter coverage details including attaching certificates of insurance. When all insurance providers are done, the compliance engine evaluates whether the vendor meets the minimum insurance requirements set up by the client. Exceptions can be routed for review to designated reviewers inside or outside of the client's organization. Reviewers can request revisions to either insurance providers directly or the vendor. Throughout the process, the vendor can update insurance providers which will preferably be notified automatically by the system. Preferably, insurance providers can also return their tasks back to the vendor or reassign them to another individual in their organization.

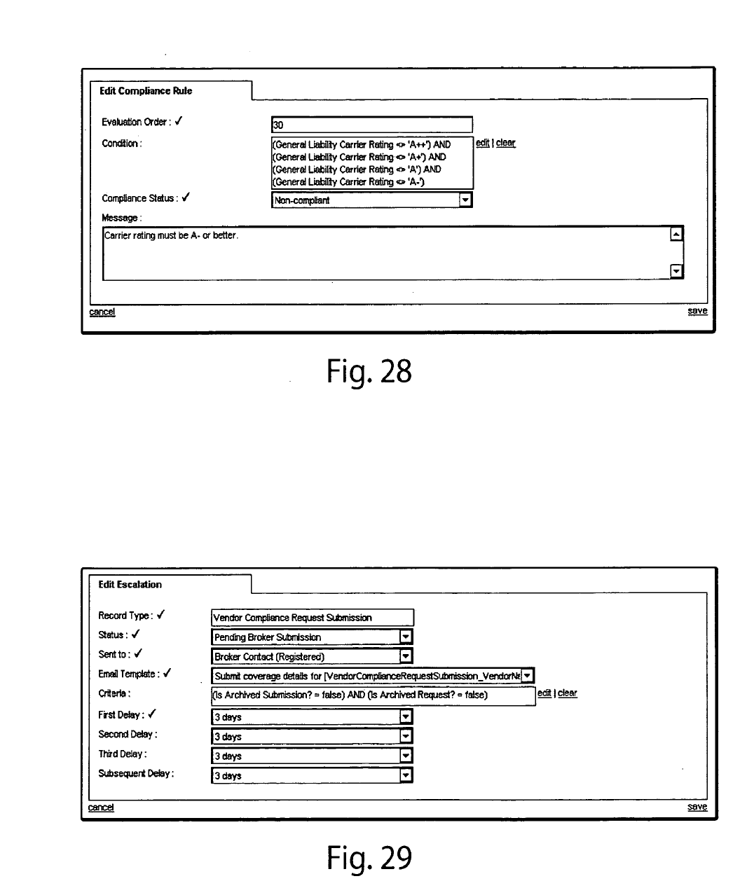

Compliance rules may then be set up on a per-coverage basis, that is, general liability will have different compliance rules from property. Compliance rules are arbitrary expressions that reference the fields of an extended coverage submission record. For example, two typical compliance rules may be: (i) policy limits cannot be below a predetermined amount; and (ii) additional insured status must be granted. When a rule is not satisfied the request is deemed not compliant and a reason is provided. Compliance rules may be defined and configured online with a point-and-click interface, as shown in FIG. 28.

The vendor compliance process preferably has multiple aspects and consequently bottlenecks can arise at different stages in its lifecycle. To mitigate these situations, the system is equipped with a comprehensive set of email reminders and escalations for each of the different stages of the process. For example, rules can be easily set up to send a reminder to insurance providers that have submitted coverage details one week after they received the task, and then follow up every three days until they take some action. An example of a reminder setup form in shown in FIG. 29. Similar reminders can be setup for reviewers and vendors. The subject and memo of the emails preferably can be modified to meet the language and needs of the customer.

Vendor compliance is preferably continuously monitored for expiring policies, lowering of financial ratings of carrier companies and other predetermined conditions that can cause a vendor to be non-compliant with the client's minimum insurance requirements. The system preferably automatically handles the expiration of a vendor policy by sending an email reminder to the appropriate insurance provider(s) 30 days in advance. If the insurance provider(s) do not enter the details of the new policy in time, the vendor (and optionally the reviewer) will preferably be notified until the situation is corrected.

The recommendations module is preferably a web-based application that allows risk managers to track and manage risk control recommendations. Engineers submit surveys and recommendations online. Loss prevention managers, often working with risk control consultants, prioritize and act upon the submitted recommendations. The system tracks project status and progress.

The configuration and setup of the recommendations module is preferably handled via an online administration user interface and does not require any programming. Business analysts and implementation engineers are preferably able to configure risk scores, language, forms, and review/approval workflows to the particular needs of the customer.

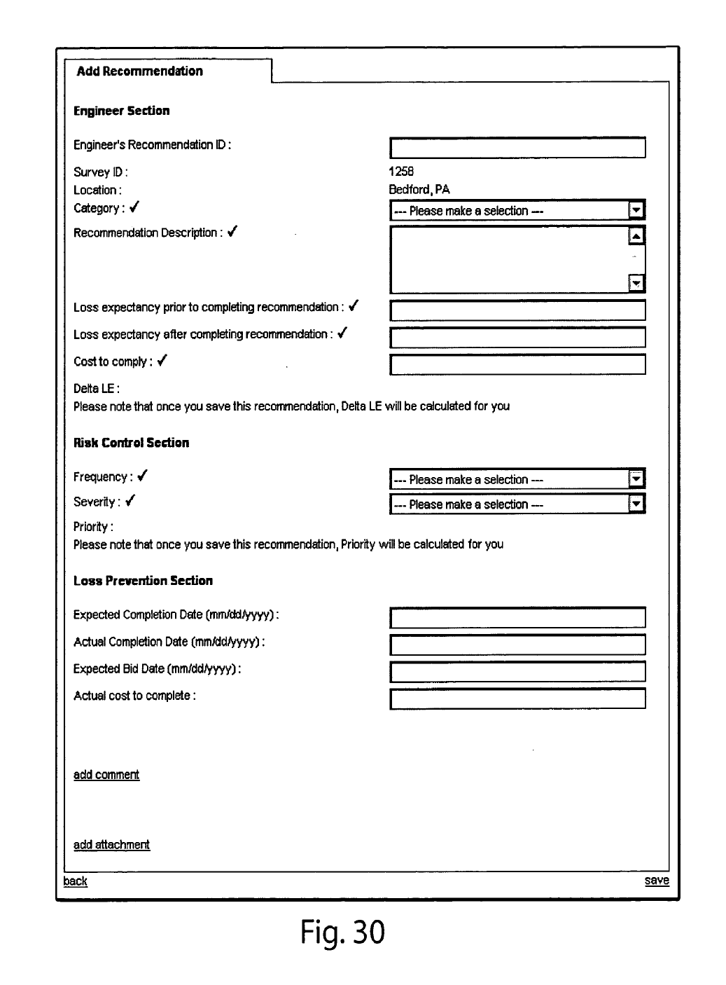

Engineers preferably submit recommendations using a web form (e.g., FIG. 30) that contains standard fields such as recommendation number and description but also can be extended with custom fields. Several recommendations comprise a survey that can also be extended with custom fields.

Recommendations submitted by engineers are preferably sent to loss prevention managers (LPMs) to review and act upon. LPMs preferably can decide to implement a recommendation, decide that it is not feasible, or sent it for further review to risk control consultants. When all the recommendations on a survey are addressed, the survey is preferably closed.

Recommendations are preferably configured with a pre-defined set of risk metrics (such as, expected loss) before and after the recommendation is implemented, estimated and actual cost to implement, and more. The actual metrics are preferably calculated on an individual record basis and can be visualized on the recommendation form and/or optionally used to affect the review process. Risk metrics are preferably defined, updated and managed in an ad hoc fashion to be aligned with the customer's internal standards, goals and initiatives.

The treasury application can be designed to improve contingent liabilities processes and reporting by capturing request details electronically and automatically routing the request to appropriate reviewers and approvers. The application can allow users to track the status of all requests and to view historical information. In addition, the application can provide online help and education regarding the process.

The configuration and setup of the treasury application is preferably handled via an online administration user interface and does not require any programming. Business analysts and implementation engineers are preferably able to configure review, approval, issuance and bidding workflows, language and forms to the particular needs of the customer.

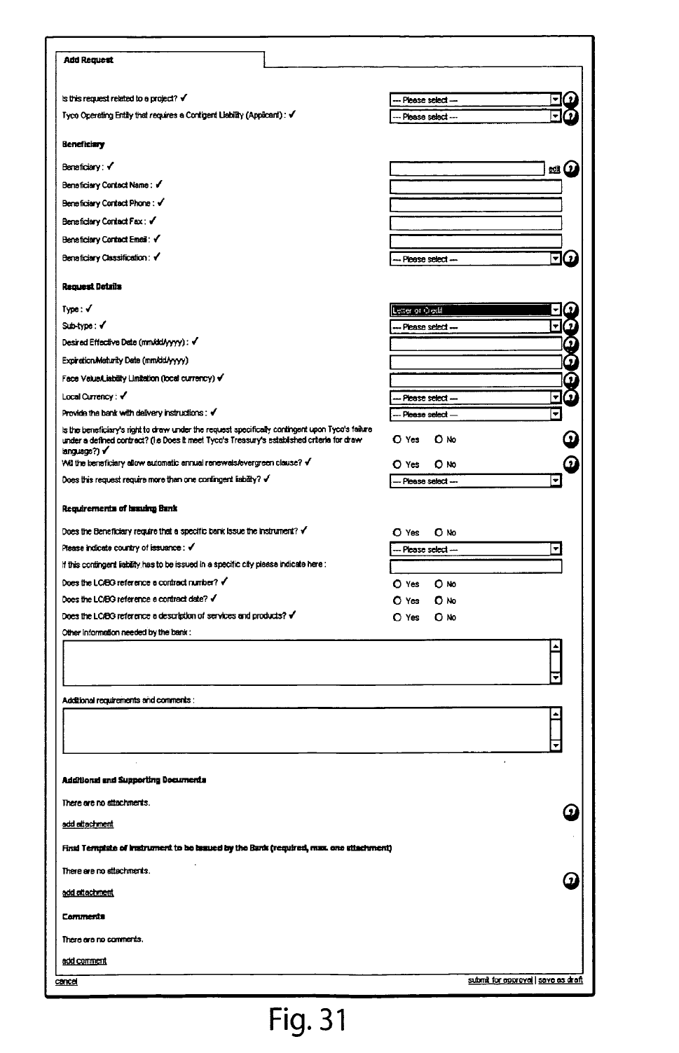

Each instantiation of the treasury application typically contains several contingent liability types, which determine the forms that are filled out by requestors. All contingent liability request forms should preferably have standard fields regardless of type, such as applicant and beneficiary details. Furthermore, the forms should be extended with custom fields that are applicable to a specific type, such as bank details in case of bank guarantees and letters of credit. A type of Contingent Liability Request Form is shown in FIG. 31.

Contingent liability request review and approval rules should comprise conditional logic statements that reference the fields of an extended contingent liability record. Rules can be easily configured to support both serial and parallel approval workflows with several review and approval levels and queues. Furthermore, escalation rules can be configured to specify timeframes when tasks are escalated from one role/level to another. Ad hoc reassignment of tasks is also supported.

Once the request for a contingent liability is approved, the instrument has to be issued. The issuance workflow varies greatly based on the instrument type. For example, bank guarantees and letters of credits must be issued by third-parties such as banks. As a further example, restrictive cash and comfort letters are typically issued internally by treasury or legal analysts. As a further example, surety bonds are issued by insurance companies. The workflow can preferably be configured to support any process used by the customer.

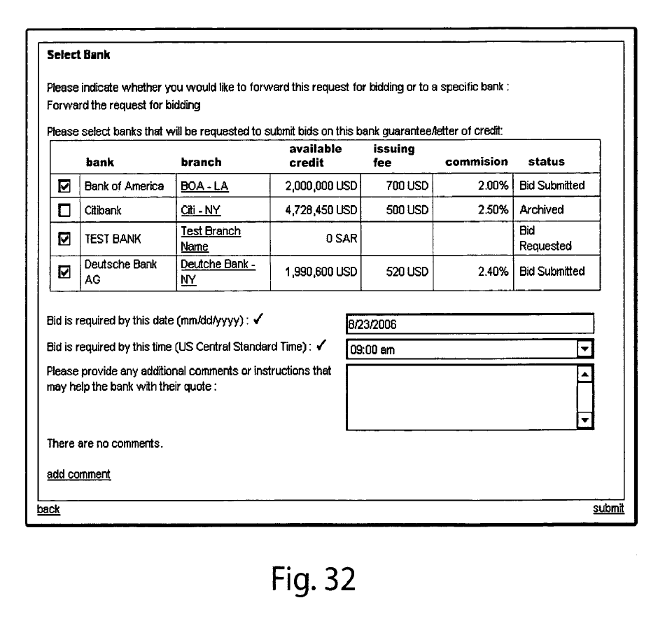

The issuance of instruments such as bank guarantees and letters of credit is done by third-party banks. The issuing bank can be predetermined, but when the face value of the instrument is considerable, it is advantageous to have different banks bid for the business. In addition to the approval and issuance workflows, the treasury preferably contains a bidding workflow that facilitates the banks bidding process. The bidding process owner can specify who the bidders will be and set a time limit for when the bids are made. Furthermore, the process owner can ask for amendments, invite new banks to bid, and eventually award the business to highest bidder. Bidding banks are notified automatically from the system. An example of a bidding form is shown in FIG. 32.

### DEFINITIONS

Any and all published documents mentioned herein shall be considered to be incorporated by reference, in their respective entireties, herein to the fullest extent of the patent law. The following definitions are provided for claim construction purposes:

Present invention: means at least some embodiments of the present invention; references to various feature(s) of the “present invention” throughout this document do not mean that all claimed embodiments or methods include the referenced feature(s).

First, second, third, etc. (“ordinals”): Unless otherwise noted, ordinals only serve to distinguish or identify (e.g., various members of a group); the mere use of ordinals implies neither a consecutive numerical limit nor a serial limitation.

Unless otherwise explicitly provided in the claim language, steps in method steps or process claims need only be performed in the same time order as the order the steps are recited in the claim only to the extent that impossibility or extreme feasibility problems dictate that the recited step order be used. This broad interpretation with respect to step order is to be used regardless of whether the alternative time ordering(s) of the claimed steps is particularly mentioned or discussed in this document—in other words, any step order discussed in the above specification shall be considered as required by a method claim only if the step order is explicitly set forth in the words of the method claim itself. Also, if some time ordering is explicitly set forth in a method claim, the time ordering claim language shall not be taken as an implicit limitation on whether claimed steps are immediately consecutive in time, or as an implicit limitation against intervening steps.

1. A system for managing risk, comprising:
a computerized platform including:
a process server module including a plurality services components,
a risk module including a plurality of graphical user interfaces forming a portal through which a user can manage information flow in connection with risk management, and
one or more insurance business process applications for managing specific risk management tasks; and
a database system communicatively coupled to the computerized platform for storing and providing access to information used by the platform;
wherein the information is received from one or more users of the platform and processed by the platform to enable the one or more users to manage risk.

2. A computer-implemented method for managing risk, the method comprising:
receiving information from a plurality of users related to one or more aspects of risk;
storing the information in a database; running at least one insurance business process application corresponding to the one or more aspects of risk on at least a portion of the information;
populating one or more graphical interfaces with the processed information for display to the users; and
generating one or more tasks or reminders based on the processed information.

3. A system comprising a set of computer hardware set and software, wherein:
the hardware is structured, connected and or programmed to run the software; and
the software comprises:
a plurality of insurance business applications, with each insurance business application being programmed to address a specific risk management process, and
a risk module programmed to serve as a common foundation for the plurality of insurance business applications.

4. The system of claim 3 wherein the risk module comprises:
an inbox sub-module;
a projects sub-module;
a documents sub-module;
a contacts sub-module;
a policies sub-module;
a reports sub-module; and
an on-line assistance sub-module.

5. The system of claim 3 wherein the plurality of insurance business applications includes a certificates business application programmed to communicate certificates of insurance.

6. The system of claim 3 wherein the plurality of insurance business applications includes an exposures business application programmed to collect exposure data.

7. The system of claim 6 wherein the exposures business application is further programmed to support a plurality of distinct reporting hierarchies.

8. The system of claim 3 wherein the plurality of insurance business applications includes a contracts business application programmed to perform contract review.

9. The system of claim 3 wherein the plurality of insurance business applications includes a vendors business application programmed to ensure vendor insurance compliance.

10. The system of claim 9 wherein the vendors business application is further programmed to allow a vendor's insurance provider to verify coverage and terms that are in place for the vendor.

11. The system of claim 3 wherein the plurality of insurance business applications includes a recommendations business application programmed to track and manage risk control recommendations.

12. The system of claim 3 wherein the plurality of insurance business applications includes a treasury business application programmed to process contingent liabilities by capturing request details of a request and automatically routing the request to at least one appropriate reviewer.

13. The system of claim 3 wherein the plurality of insurance business applications includes:
a certificates business application programmed to communicate certificates of insurance;
an exposures business application programmed to collect exposure data;
a contracts business application programmed to perform contract review;
a vendors business application programmed to ensure vendor insurance compliance;
a recommendations business application programmed to track and manage risk control recommendations; and
a treasury business application programmed to process contingent liabilities by capturing request details of a request and automatically routing the request to at least one appropriate reviewer.

14. A system comprising a set of computer hardware set and risk management module, wherein:
the hardware is structured, connected and or programmed to run the software;
the risk management module software comprises a risk management workflow framework comprising:
trigger event code programmed to allow a user to define a trigger event related to risk management, and
workflow transition definition code programmed to allow a user to define a workflow transition associated with at the trigger event.

15. The system according to claim 14 wherein the workflow framework module further comprises rule definition code programmed to allow a user to associate a rule with the trigger event and to specify at least one triggered action to be caused upon occurrence of the trigger event according to an event-action paradigm.

16. The system according to claim 15 wherein the triggered action includes one or more of the following: an escalation, a reminder, a task, an email and/or dynamic assignment of a task to a user based on her role.

17. A system comprising a set of computer hardware set and risk management software, wherein:
the hardware is structured, connected and or programmed to run the software; and
the risk management software comprises an exposures application programmed to collects exposure data by sending communications to a plurality of exposure related parties corresponding to a plurality of users, with exposures application comprising:
reassignment code programmed to reassign a correspondence between an exposure related party and the corresponding user acting as the exposure related party from a first original user to a reassignment user, and
delegation code programmed to delegate a correspondence between an exposure related party and the corresponding user acting as the exposure related party from a second original user to a delegated user.

18. A system comprising a set of computer hardware set and risk management software, wherein:
the hardware is structured, connected and or programmed to run the software; and
the risk management software comprises a vendors application programmed to automate and streamlines vendor insurance compliance by communicating directly with a vendor's insurance provider to verify coverage and terms that are in place for the vendor.

19. The system of claim 18 wherein the vendor's insurance provider is one of the following types: broker, agent, or carrier.
